(19) United States
(12) Patent Application Publication
(10) Pub. No.: US 2016/0002078 A1
(43) Pub. Date: Jan. 7, 2016

(54) AERATED BED BIOFILM REACTOR

(71) Applicant: MAPAL GREEN ENERGY LTD., Kibutz Yagur (IL)

(72) Inventor: Hanoch MAGEN, Kiryat Haim (IL)

(21) Appl. No.: 14/768,420

(22) PCT Filed: Feb. 18, 2014
(86) PCT No.: PCT/IL2014/050176

§ 371 Date: Aug. 17, 2015

Related U.S. Application Data
(60) Provisional application No. 61/765,985, filed on Feb. 18, 2013.

(51) Int. Cl. C02F 3/08

(52) U.S. Cl. CPC C02F 3/082; C02F 2101/16

(57) ABSTRACT

According to the present invention there is provided a treatment assembly for a basin containing a fluid medium. The assembly comprises an aeration device configured for infusing air to the fluid medium. The assembly further comprises a carrier arrangement, mounted onto the aeration device and configured for supporting bio-media providing a substrate for the growth thereon of biomass within the fluid medium. The biomass is configured for consuming at least a part of the air infused by the aeration device.

### FIELD OF THE INVENTION

This invention relates to biofilm reactors and aeration devices for fluid basins.

### BACKGROUND OF THE INVENTION

Known in the art are devices adapted to infuse air into basins of water and other fluid materials, this infusion being generally referred to as aeration. The aeration may be performed for different purposes. For example, aeration devices can be used in wastewater treatment plants to perform improvement of de-nitrification

One type of aeration device is in the form of a piping network deployed over a basin and having pipe extensions lowered below the water level in the basin to provide air thereto.

Another type of aeration device is in the form of fans deployed on the surface of the water of the basin, and adapted to rotate while emitting air so as to provide the desired infusion.

In basins, it is also known to use a Moving Bed Biofilm Reactor (MBBR) technology in order to improve aeration and treatment of the fluid medium. MBBR technology employs thousands of polyethylene bio-media operating in mixed motion within an aerated wastewater treatment basin. Each individual biocarrier increases productivity through providing protected surface area to support the growth of heterotrophic and autotrophic bacteria within its cells. It is this high-density population of bacteria that achieves high-rate biodegradation within the system, while also offering process reliability and ease of operation.

This technology provides cost-effective treatment with minimal maintenance since MBBR processes self-maintain an optimum level of productive biofilm. Additionally, the biofilm attached to the mobile biocarriers within the system automatically responds to load fluctuations.

### SUMMARY OF THE INVENTION

According to one aspect of the subject matter of the present application there is provided a treatment assembly for a basin containing a fluid medium, said assembly comprising an aeration device configured for infusing air to said fluid medium and a carrier arrangement, mounted onto said aeration device and configured for supporting bio-media providing a substrate for the growth thereon of biomass within said fluid medium, configured for consuming at least a part of the air infused by said aeration device.

The arrangement is such that the air emitted from the aeration device is configured to pass through the bio-media held by the carrier arrangement, thereby increasing oxygen intake by the bio-mass growing thereon, and, in particular, increase de-nitrification of the fluid medium.

Said aeration device can be similar to that described in US2011/121472 to the applicant, which is incorporated herein by reference.

In particular, the aeration device can comprise:
an elongated primary distribution member having a proximal end adapted to be connected to a gas source and a distal end adapted to be immersed into said medium;
at least one aeration member connected to the primary distribution member at a location on said distribution member spaced from said proximal end thereof, being in fluid communication with the distribution member and being adapted for bringing said gas into a state entrappable within said liquid medium; and
a flotation member mounted onto said primary distribution member and adapted to assume various positions along said distribution member between said proximal end and said location at which the aeration member is connected to the distribution member, according to the level of the liquid medium.

The carrier arrangement can be mounted on the primary distribution member of the aeration device, between the floatation member and the aeration member. According to one example, the carrier arrangement can be fixedly mounted onto the primary distribution member, so that the carrier arrangement and aeration device perform as a single body.

Alternatively, the carrier arrangement can be mounted onto the primary distribution member in a movable manner, allowing displacement/rotation thereof with respect to the aeration device.

In particular, the aeration device can have a central axis so that at least one of the following is provided:
axial displacement of the carrier arrangement along said axis, relative to said floatation member; and
rotary displacement between said carrier arrangement and said aeration member about said axis.

The carrier arrangement can be any arrangement defining a confined space within which bio-media is disposed, allowing passage of fluid into and out of said confined space while preventing escape of the bio-media from the confined space.

According to one example, the carrier arrangement can be in the form of a cage configured for accommodating therein the bio-media. The cage can have gridded and/or perforated side walls, allowing passage of fluid through the cage side walls while preventing escape of the bio-media from the carrier arrangement.

According to another example, the carrier arrangement can be in the form of a plurality of carrier arms, each of which is configured for mounting thereon or associating therewith of bio-media.

The aeration device can comprise a central conduit having a diffuser portion at one end and a float at a second send, so that, when said aeration device is located within the basin, said central conduit extends generally vertically with said float at the level of the fluid and said diffuser portion being submerged within said fluid.

The arrangement can be such that air is emitted from the diffuser portion, which consequently rises up to a top level of the basin. In particular, the carrier arrangement can be disposed between said diffuser portion and said float portion so that air emitted from the diffuser portion is configured for first passing through the carrier arrangement, and consequently through said bio-media.

One advantage of the above design is in its allowing constant air-flushing of the bio-media, thereby preventing the bio-media, along with its on-growing bio-mass, from clogging the carrier arrangement.

According to a particular example, the carrier arrangement can be configured for spontaneously performing the above axial/rotational displacement, thereby providing additional circulation of air and fluid around the bio-mass for better cleaning thereof. In particular, such displacement can be performed as a result of the constant emission of air from the diffusers, dynamically affecting the bio-media and consequently the carrier arrangement.

According to another example, rotation of the carrier arrangement about the central conduit can be provided by a drive mechanism, and be performed on cue by an operator or by a set controller (yielding a predetermined displacement/rotation through time).

The carrier arrangement can be removable and can be in the form of a mountable unit. Under this example, the carrier arrangement can be mounted onto an existing aeration device and also removed therefrom for the purpose of maintenance etc.

The carrier arrangement can be mounted on the aeration device so that a top end of the carrier arrangement is still spaced from the proximal end of the primary distribution member, thereby allowing the floatation member with a predetermined axial space for performing axial movement along the primary distribution member.

It is appreciated that in the aeration device without the carrier arrangement, the primary purpose of axial displacement of the floatation member is preventing a situation in which the fluid level of the basin drops below the level of the flotation member, thereby turning it into a ‘sail’, which may cause tipping over of the aeration device.

In comparison, the axial movement of the floatation member of the present aeration device is considerably limited. However, since the carrier arrangement is mounted onto the aeration device and includes a considerable mass of bio-media, it serves as a counterweight preventing the above tipping-over, compensating for the reduced axial displacement of the floatation member.

In other words, even if the fluid level of the basin falls below the floatation member, the counterweight of the carrier arrangement and carriers will be sufficient for preventing tipping-over of the aeration device.

Thus, according to the subject matter of the present application, the carrier arrangement is configured for accommodating a bio-media, the weight of which, together with the weight of the bio-mass growing therein and the carrier arrangement itself are sufficient for preventing tipping over of the aeration device, even when the flotation member is at the proximal end and the fluid level drop below the floatation member.

In accordance with another aspect of the subject matter of the present application, there is provided a method for increasing the aeration properties of an aeration device by adding to said aeration device a carrier arrangement configured for supporting bio-media providing a substrate for the growth thereon of biomass within said fluid medium, configured for consuming at least a part of the air infused by said aeration device.

It is appreciated that under the above method, within a basin containing several aeration devices, not all of the aeration devices must be fitted with a carrier arrangement, and so, some aeration devices can continue regular operation. The remainder of the aeration devices are each provided with a carrier arrangement, thereby bringing the aeration properties to the desired values.

The above method can allow upgrading treatment capacity at existing reactors and new reactors as well, especially the de-nitrification process performed thereby.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1A is a schematic isometric view of an aeration device according to the subject matter of the present application;

FIG. 1B is a schematic front view of the aeration device shown in FIG. 1A;

FIG. 1C is a schematic front view of the aeration device shown in FIG. 1B, with the float member in a lowered position;

FIG. 2A is a schematic front view of an aeration device according to another example of the subject matter of the present application;

FIG. 2B is a schematic top view of the aeration device shown in FIG. 2A; and

FIGS. 3A and 3B are schematic isometric views of examples of bio-media used in the aeration device of the present application.

### DETAILED DESCRIPTION OF EMBODIMENTS

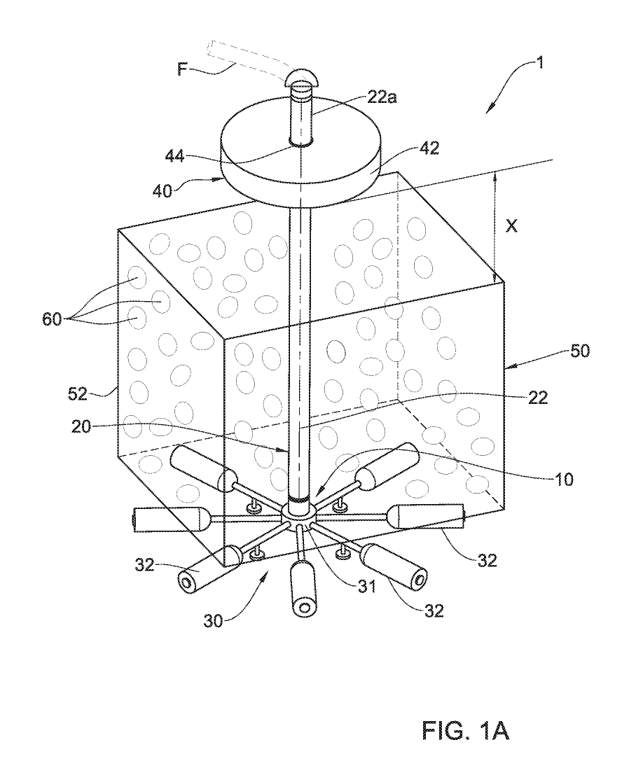

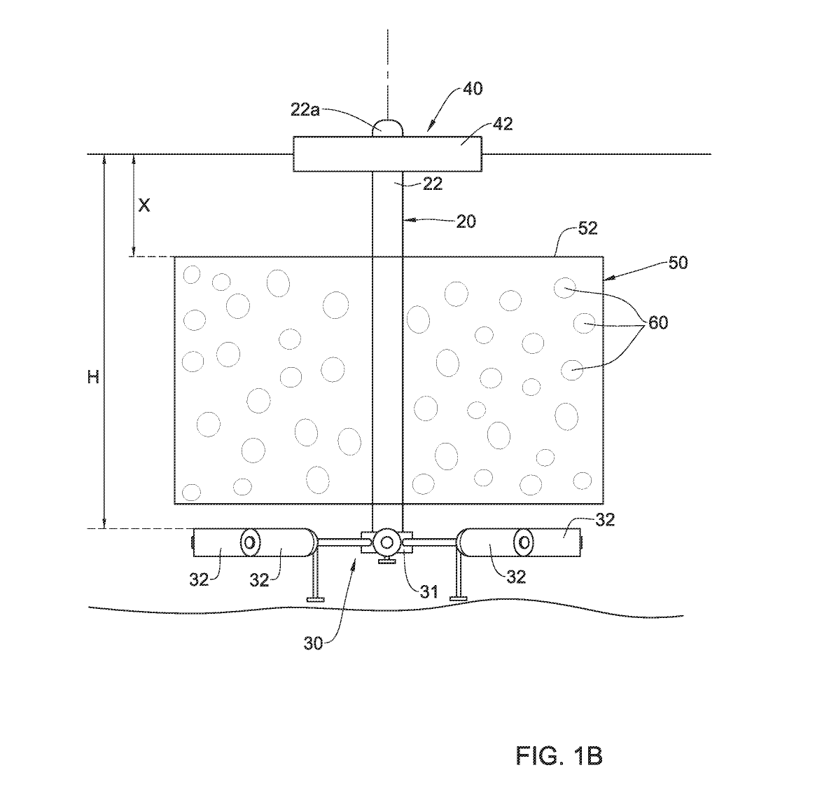

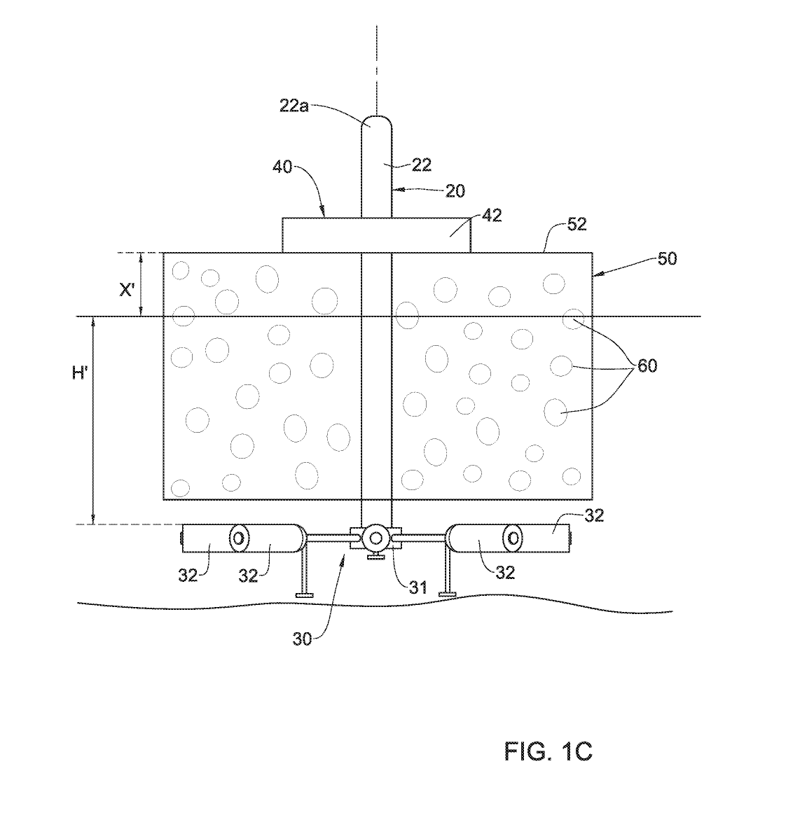

Attention is first drawn to FIGS. 1A and 1B, in which an aeration assembly is shown, generally designated as 1, and comprising an aeration device 10 and an Aerated Bed Biofilm Reactor (ABBR) construction 50 mounted thereon.

The aeration device 10 comprises a shaft structure 20, a distribution arrangement 30 articulated to a bottom end 22b of the shaft structure 20 and a floatation unit 40 slidingly mounted over the shaft structure 20 at a top end 22a thereof.

The ABBR construction 50 comprises a cage 52 accommodating therein a plurality of bio-media 60, freely disposed within the cage 52. However, it is noted that the ABBR does not have to be in the form of a cage and can also be constituted by a plurality of arms, carrier surface/s etc.

The shaft structure 20 comprises a main shaft 22 which is associated, at a top end 22a thereof with a feed line F configured for providing it with an aeration gas (usually air). At the bottom end 22b, the main shaft 22 is provided with a diffuser arrangement 30 comprising a main hub 31 to which a plurality of diffusers 32 are articulated.

In operation, aeration gas provided through the feed line F progresses along the main shaft 22 towards the bottom end 22b, passes into the hub 31 and then distributed into the diffusers 32 which are configured for emitting the aeration gas into the liquid medium in which the entire aeration assembly 1 is disposed.

The flotation unit 40 comprises a float member 42 slidingly mounted over the main shaft 22 via an opening 44 therein. This manner on mounting the float member 42 allows it to freely slide along the main shaft 22, thereby constantly remaining at the liquid medium level of the basin, i.e. is driven by virtue of the level of the liquid medium alone.

As seen in FIG. 1A, the float member 42 can displace along the main shaft 22 along a distance X from the top end 22a to the top edge of the cage 52. It is appreciated that one of the purposes for slidingly mounting the float member onto the main shaft 22 is preventing suspension of the float member above the liquid medium level (in case the liquid medium level drops), thereby preventing the entire aeration assembly 1 from functioning as a sail which may be knocked down by the wind.

As shown in FIG. 1C, when the level of the medium in the basin drops to H′, the float member 42 also drops, shown, in this example, to be resting on a top portion of the cage 52. The level of the basin is now lower than the top portion of the cage 52 yielding a distance X′ between the float and the level of the medium.

However, on the one hand, the distance X is limited by the top wall of the cage 52, wherein, if the liquid medium level drops more than X, the float member 42 will turn to rest on the top wall of the cage 52. On the other hand, the weight of the cage 52 and the bio-media 60 contained therein is sufficient from preventing ‘tipping over’ of the entire aeration assembly 1.

In operation, aeration gas emitted from the diffusers 32 begins ascending to the surface of the liquid medium. During this ascent, the aeration gas passes through the plurality of bio-media 60, achieving at least two effects:
(a) provision of aeration gas and increasing the biological growth on the bio-media 60 due to an increase in oxygen levels; and
(b) carrying away biological material from the carriers 60, thereby reducing clogging within the cage.

In the Example shown in FIG. 1A, the cage 52 is also slidingly mounted over the main shaft 22, so that it is free to displace vertically along the shaft 22 as well as rotate thereabout. Since the cage 52 and carriers 60 constitute a considerably mass, the ABBR construction is constantly urged downwards by gravity. However, it is still free to rotate about the main shaft 22, thereby facilitating mixing of the carriers 60 within the cage 52 and further increasing oxygen level therein.

In addition, since the ABBR construction 50 is constantly urged downwards, it maintains a generally fixed distance from the distribution arrangement 30, facilitating uniformity in the effect of the aeration process.

As observed from FIG. 1B, when the level of the liquid medium drops considerably, the aeration assembly 1 is configured to rest on the bottom of the basin using leg supports 37 extending from the bottom side of the distribution arrangement 30.

It is appreciated that the ABBR construction 50 can be provided with securing elements (not shown) configured for affixing the position of the cage 52 along the main shaft 22. In particular, the distance of a bottom wall of the cage 52 from the distribution arrangement 30 can be designed according to the properties of the diffusers, the flow rate of distributed aeration gas etc.

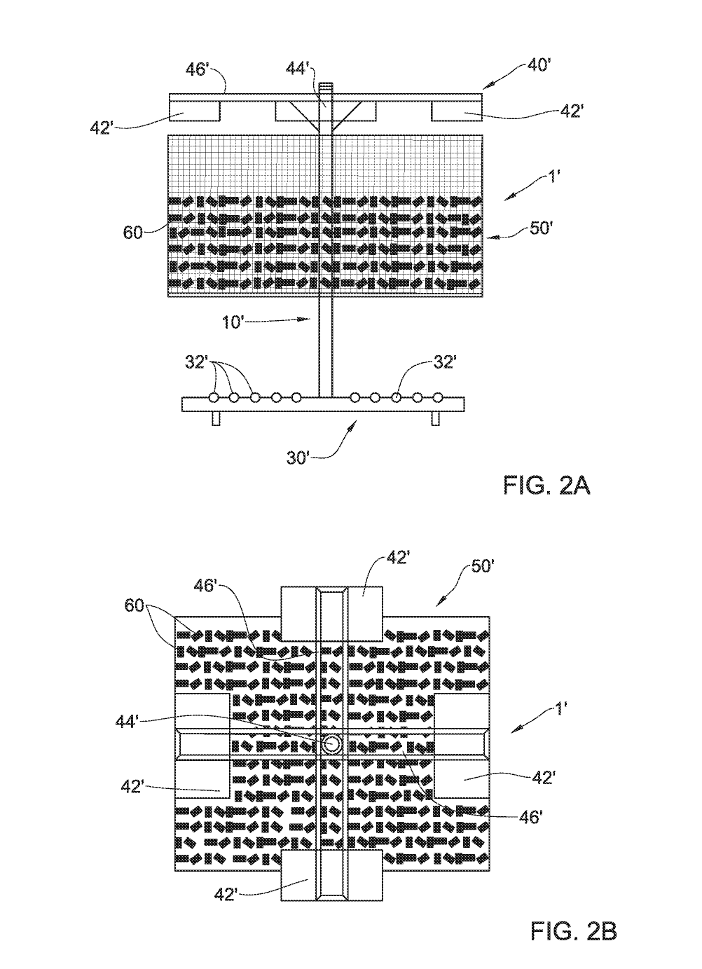

Turning now to FIGS. 2A and 2B, another example of an aeration assembly is shown, generally designated 1′ which is, in principle, similar in construction to the aeration assembly 1 previously described.

The main difference between the aeration assembly 1′ and the aeration assembly 1 lies in the design of the floatation unit 40′. In particular, the floatation unit 40′ comprises a cross-member having two arms 46′, perpendicularly intersecting one another, each carrying at each respective end thereof a floating member 42′. The cross-member is configured for sliding displacement about the main shaft 22 via a designated port 44′.

In addition, the distribution arrangement 30′ is slightly different and comprises a plurality of diffusers 32′ extending parallel to one another instead of radially as diffusers 32 of the previous example.

Nonetheless, the same advantages previously described with respect to the aeration assembly 1 are also provided by the current example of aeration assembly 1′.

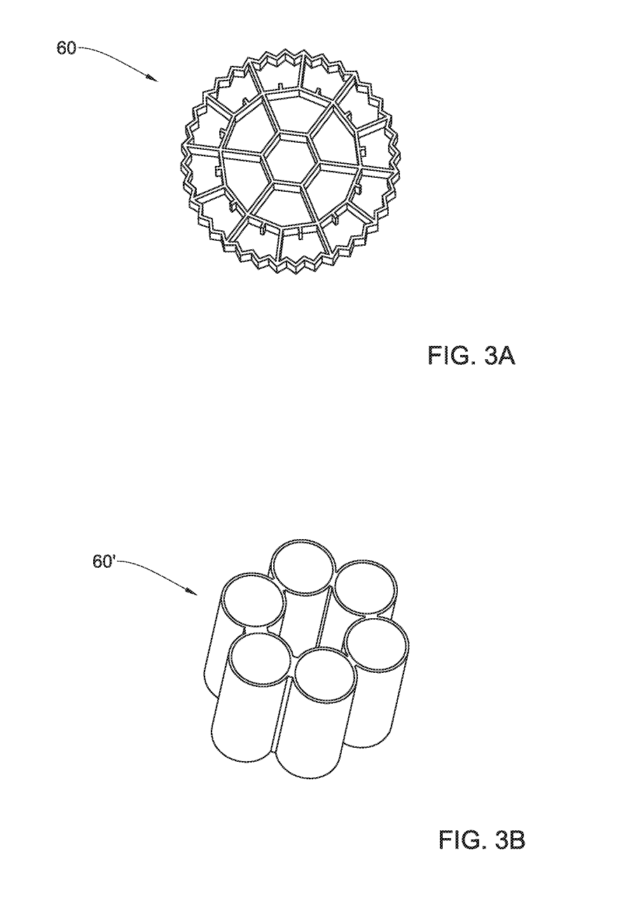

With reference to FIGS. 3A and 3B, examples of bio-media 60, 60′ are shown which may be used within the ABBR construction 50, 50′ of the above described examples of the aeration assemblies 1, 1′.

With reference to all of the above, it is appreciated that the ABBR construction 50, 50′ can be added to existing aeration devices 10, 10′. In particular, when it is required to increase the efficiency of aeration of a liquid medium in a predetermined basin, it may be beneficial to provide one or more of such aeration devices, already operating within the basin, with an ABBR construction.

According to the subject matter of the present application, there is provided a method for increasing the aeration within a basin comprising one or more aeration devices, as follows:

For example, a basin comprises several aeration devices 10, providing a predetermined amount A of oxygen pet unit time into the liquid medium. It is required to increase the aeration of the liquid medium within the basin to be equivalent to 1.5 A. In principle, a general solution would be to introduce several additional aeration devices, thereby increasing the oxygen intake and output by 1.5 time. However, it may be desired to achieve a similar effect without actually increasing the number of aeration devices and, more importantly, the amount of aeration gas actually introduced into the liquid medium.

According to the method of the present application, some of the aeration devices 10 are provided with an ABBR construction as described in connection with FIGS. 1A to 2B.

The addition of the ABBR constructions to some of the aerators to constitute the aeration system of the present application increases the aeration efficiency within the entire basin and provides a similar effect to that of providing additional aeration devices.

Those skilled in the art to which this invention pertains will readily appreciate that numerous changes, variations, and modifications can be made without departing from the scope of the invention, mutatis mutandis.

1-20. (canceled)

21. A treatment assembly for a basin containing a fluid medium, said assembly comprising:
an aeration device configured for infusing air to said fluid medium; and
a carrier arrangement, mounted onto said aeration device and configured for supporting bio-media providing a substrate for growth thereon of biomass within said fluid medium, the biomass configured for consuming at least a part of the air infused by said aeration device.

22. The treatment assembly according to claim 21, wherein the air emitted from the aeration device is configured to pass through the bio-media held by the carrier arrangement.

23. The treatment assembly according to claim 21, wherein said aeration device includes:
an elongated primary distribution member having a proximal end adapted to be connected to a gas source and a distal end adapted to be immersed into said medium;
at least one aeration member connected to the primary distribution member at a location on said distribution member spaced from said proximal end thereof, being in fluid communication with the distribution member and being adapted for bringing said gas into a state entrappable within said liquid medium; and
a flotation member mounted onto said primary distribution member and adapted to assume various positions along said distribution member between said proximal end and said location at which the at least one aeration member is connected to the distribution member, according to the level of the liquid medium.

24. The treatment assembly according to claim 23, wherein the carrier arrangement is mounted on the elongated primary distribution member of the aeration device, between the floatation member and the at least one aeration member.

25. The treatment assembly according to claim 24, wherein the carrier arrangement is fixedly mounted onto the elongated primary distribution member, so that the carrier arrangement and the aeration device perform as a single body.

26. The treatment assembly according to claim 24, wherein the carrier arrangement is mounted onto the elongated primary distribution member in a movable manner, allowing displacement/rotation thereof with respect to the aeration device.

27. The treatment assembly according to claim 26, wherein the aeration device has a central axis so that at least one of the following is provided:
axial displacement of the carrier arrangement along said axis, relative to said floatation member; or
rotary displacement between said carrier arrangement and said at least one aeration member about said axis.

28. The treatment assembly according to claim 27, wherein the carrier arrangement is configured for spontaneously performing at least one of the axial displacement or the rotational displacement.

29. The treatment assembly according to claim 28, wherein the at least one of the axial displacement or the rotational displacement is performed as a result of the constant emission of air from the diffusers, dynamically affecting the bio-media and, consequently, the carrier arrangement.

30. The treatment assembly according to claim 27, wherein displacement/rotation of the carrier arrangement about the central conduit is provided by a drive mechanism operated by a user.

31. The treatment assembly according to claim 21, wherein the carrier arrangement is in the form of a cage configured for accommodating therein the bio-media.

32. The treatment assembly according to claim 31, wherein the cage has gridded and/or perforated side walls, allowing passage of fluid through cage side walls of the cage, while preventing escape of the bio-media from the carrier arrangement.

33. The treatment assembly according to claim 21, wherein the carrier arrangement is in the form of a plurality of carrier arms, each of which is configured for mounting thereof or associating therewith of bio-media.

34. The treatment assembly according to claim 21, wherein the aeration device includes a central conduit having a diffuser portion at one end and a float at a second send, so that, when said aeration device is located within the basin, said central conduit extends generally vertically with said float at the level of the fluid and said diffuser portion is submerged within said fluid.

35. The treatment assembly according to claim 34, wherein the carrier arrangement is disposed between said diffuser portion and said float portion so that air emitted from the diffuser portion is configured for passing through the carrier arrangement, and consequently through said bio-media.

36. The treatment assembly according to claim 34, wherein the carrier arrangement is mounted on the aeration device so that a top end of the carrier arrangement is still spaced from the proximal end of the primary distribution member, thereby allowing the floatation member with a predetermined axial space for performing axial movement along the primary distribution member.

37. The treatment assembly according to claim 36, wherein the carrier arrangement, bio-media associated therewith and the bio-mass growing on the bio-media have sufficient weight to serve as a counterweight preventing tipping-over of the aeration device.

38. The treatment assembly according to claim 21, wherein the carrier arrangement is in the form of a removably mountable unit.

39. The treatment assembly according to claim 38, wherein the carrier arrangement is configured for mounting onto an existing aeration device.

40. A method for increasing aeration properties of an aeration device, the method comprising:
adding to said aeration device a carrier arrangement configured for supporting bio-media providing a substrate for growth thereon of biomass within said fluid medium, configured for consuming at least a part of the air infused by said aeration device.
